(19) United States
(12) Patent Application Publication
(10) Pub. No.: US 2023/0103706 A1
(43) Pub. Date: Apr. 6, 2023

(54) METHOD FOR OPERATING A WIND POWER INSTALLATION

(71) Applicant: Wobben Properties GmbH, Aurich (DE)

(72) Inventor: Frank Bunge, Ludwigshafen (DE)

(21) Appl. No.: 17/956,637

(22) Filed: Sep. 29, 2022

(30) Foreign Application Priority Data
Oct. 1, 2021 (EP) 21200588.8

(51) Int. Cl. F03D 7/02

(52) U.S. Cl. CPC F03D 7/0204; F05B 2270/327

(57) ABSTRACT

The present invention relates to a method for operating a wind power installation, comprising the steps of: sensing at least one angular velocity of the wind power installation, in particular by use of a rotation rate sensor in a hub of the wind power installation, preferably for the purpose of sensing a tilt of the nacelle; sensing a reference value for the at least one sensed angular velocity; determining at least one state variable of the wind power installation from the at least one angular velocity and the reference value; controlling the wind power installation in dependence on the state variable, in particular such that the state variable becomes smaller.

### BACKGROUND

### Technical Field

The present invention relates to a method for operating a wind power installation, in particular for identifying eigenmodes of a tower of a wind power installation, preferably a second tower eigenmode.

### Description of the Related Art

Wind power installations are commonly known and usually embodied as horizontal rotors, i.e., the kinetic energy extracted from wind is converted into a mechanical rotary motion about a substantially horizontal axis of rotation located on a tower of a wind power installation. This axis of rotation is also referred to as the main axis of rotation of the wind power installation.

The tower of such horizontal rotors is designed in particular in consideration of the nominal rotational speed of the aerodynamic rotor of the wind power installation and in consideration of the first eigenfrequency of the tower, for example by means of the so-called Campbell diagram, according to which towers of wind power installations are designated as stiff-stiff, soft-stiff or soft-soft.

In the case of a stiff-stiff tower, the first eigenfrequency, i.e., the lowest resonance frequency, of the tower, in the range of the nominal rotational speed of the wind power installation, is above three times the nominal rotational speed (3p).

In the case of a soft-stiff tower, the first eigenfrequency, i.e., the lowest resonance frequency, of the tower, in the range of the nominal rotational speed of the wind power installation, is below three times the nominal rotational speed (3p) and above one times the nominal rotational speed (1p).

In the case of a soft-soft tower, the first eigenfrequency, i.e., the lowest resonance frequency, of the tower, in the range of the nominal rotational speed of the wind power installation, is below one times the nominal rotational speed (1p).

Despite all care and despite consideration of the first eigenfrequency, the design of the tower can result in resonant tower oscillations that are excited by the wind and lie in the resonance range of the wind power installation and that thus result in large loads within the tower, for which reason it is necessary, for example, to curtail or even shut down the wind power installation.

In the case of the soft-soft towers, in particular, resonant oscillations in the range of the second eigenfrequency of the tower could be observed.

### BRIEF SUMMARY

Provided is a method for controlling a wind power installation that takes into consideration tower (eigen) oscillations, in particular in the range of the second eigenfrequency of the tower.

Provided is a method for operating a wind power installation, comprising the steps of: sensing at least one angular velocity of the wind power installation, in particular by use of a rotation rate sensor in a hub of the wind power installation, sensing a reference value for the at least one sensed angular velocity; determining at least one state variable of the wind power installation from the at least one angular velocity and the reference value; controlling the wind power installation in dependence on the state variable, in particular such that the state variable becomes smaller.

It is thus proposed in particular, in operating a wind power installation, to take into consideration the tower oscillations, in particular the tower eigen oscillations, preferably the tower eigen oscillations of a soft-soft tower in the range of the second eigenfrequency of the tower.

The tower oscillations, or tower eigen oscillations, are sensed, in particular indirectly, by means of a rotation rate sensor, for example by means of a gyroscope in the hub of the wind power installation.

In a first step, at least one angular velocity of the wind power installation is sensed for this purpose, in particular an angular velocity of the nacelle about an axis that is substantially parallel to the main axis of rotation of the wind power installation, or parallel to the axis of rotation of the rotor of the wind power installation.

The angular velocity may be sensed, for example, by a rotation rate sensor, preferably a gyroscope.

Preferably, the angular rate sensor is located in the hub of the wind power installation.

Also sensed, in a further step, is a reference value for this angular velocity sensed in this way.

The reference value is in particular a reference angle or a reference speed, for example a rotor position or a relative rotational speed, in particular about an axis of rotation of the rotor of the wind power installation.

A state variable of the wind power installation is then sensed from the angular velocity sensed in this way and the reference value sensed in this way.

The state variable is preferably a velocity of the nacelle, in particular rotational speed in a particular direction, for example along or about the main axis of rotation of the wind power installation, or along or about the axis of rotation of the rotor.

The velocity of the nacelle along the main axis of rotation of the wind power installation, i.e., about an orthogonal to the main axis of rotation that lies in the plane of the main axis of rotation, is also referred to as the frontal tilt speed or pitch speed, or pitch rate, of the nacelle.

The velocity of the nacelle about the main axis of rotation of the wind power installation is also referred to as the lateral tilt speed or roll speed, or roll rate, of the nacelle.

Preferably, the state variable is further prepared, in particular filtered. For example, the amplitude of the tilt speed of the nacelle is filtered in particular ranges in order to determine the second tower eigenmode of the tower of the wind power installation.

Eigenmode is understood herein in particular as the oscillation of a system when it is left to itself. The frequency of an eigenmode is also referred to as eigenfrequency.

The wind power installation is then controlled in dependence on the state variable determined in this way, in particular in such a way that the state variable becomes smaller, preferably smaller in magnitude.

If, for example, an increase in a tower (eigen)oscillation is identified, the wind power installation is controlled in such a way that the tower (eigen)oscillation, or the second tower eigenmode, decreases.

The controlling of the wind power installation is then effected, for example, by use of at least one from the following list composed of: altering a rotational speed of the wind power installation, altering a rotor rotational speed of the wind power installation, altering a generator torque of the wind power installation, altering a pitch angle of a rotor blade of the wind power installation, altering all pitch angles of all rotor blades of the wind power installation, in particular by the same angle, altering a yaw angle of the wind power installation, in particular of the nacelle.

According to a further embodiment, a wind power installation adjacent to the wind power installation may also be controlled in order to reduce the tower (eigen)oscillation, for example the second tower eigenmode, of the wind power installation. For this purpose, the rotational speed, the rotor rotational speed, the generator torque, a pitch angle of a rotor blade or the yaw angle of the adjacent wind power installation is changed, in particular in such a way that turbulence generated by the adjacent wind power installation and resulting in a tower (eigen) oscillation of the wind power installation is reduced.

If the tower (eigen) oscillation continues to increase despite these measures, for example due to unfavorable wind conditions, it is also proposed to stop, or shut down, or deactivate the wind power installation and/or to shift the operating point of the wind power installation, for example by altering the rotational speed of the wind power installation.

Preferably, the stopping and/or shifting of the operating point of the wind power installation is effected in consideration of a limit value.

Preferably, the limit value is a value for a fatigue load, for example of the tower.

The limit value thus preferably describes a limit for an excessive oscillation, in particular of the tower, over a period of time, in particular an excessively long period of time.

Preferably, the angular velocity, in particular absolute angular velocity, is sensed in one direction, the direction being along an axis of rotation of a rotor of the wind power installation, in particular along the main axis of rotation.

In particular, one angular velocity, preferably exactly one angular velocity, is sensed.

The angular velocity in this case is sensed in particular in the direction of the main axis of rotation of the wind power installation, i.e., about an axis that is perpendicular to the main axis of rotation and lies in a horizontal plane with the latter.

Preferably, the reference value is a relative rotational speed, in particular about an axis of rotation of a rotor of a wind power installation, which is sensed, for example, by a magnetic tape sensor.

It is thus also proposed to use the rotational speed of the aerodynamic rotor as the reference value.

The rotational speed of the aerodynamic rotor may be sensed, for example, by a sensor inside or outside the wind power installation.

Preferably, the rotational speed is sensed by a magnetic sensor, in particular a magnetic tape sensor. For this purpose, the magnet, or the magnetic tape, is attached to the shaft that is mechanically coupled to the aerodynamic rotor, or is placed around the shaft that is mechanically coupled to the aerodynamic rotor, and a corresponding reader head is located in the nacelle, preferably on a stationary part.

Preferably, the state variable represents a tilt speed of the nacelle of the wind power installation.

Preferably, the state variable represents the tilt speed of the nacelle of the wind power installation about the main axis of rotation.

Further preferably, the state variable indicates the tilt speed about a horizontal axis of the wind power installation, in particular about that axis which corresponds to a tilt-angle-adjusted main axis of rotation of the wind power installation, i.e., the actual horizontal axis of the wind power installation.

Preferably, the state variable is formed from a difference of the angular velocity and the reference value, for example by:

ω_{Nac,tilt}=ω_{gyro,x}−ω_{Ref}

and optionally in consideration of an angle, preferably a tilt angle, for example by:

$${ω}_{Nac , x} = \frac{{ω}_{Nac , tilt}}{cos θ} .$$

The tilt angle in this case describes an angle between the main axis of rotation of the wind power installation or the tower, in particular the base of the tower.

The tilt angle is in particular predefined by the design of the wind power installation.

If the wind power installation is in an unloaded idle state, the main axis of rotation is vertically above the base of the tower, and the tilt angle is zero degrees.

Preferably, the angular velocity and the reference value are filtered before determination of the state variable, in particular by means of a bandpass filter, preferably in order to obtain a second tower eigenmode.

It is thus proposed in particular to filter the sensed variables, in particular in such a way that conclusions can be drawn about the second tower eigenmode.

Preferably, the controlling of the wind power installation is effected with observation of the state variable.

It is thus proposed in particular to take the state variable into consideration in the control process, in particular to observe it.

The controlling is effected in particular in such a way that the state variable becomes smaller, preferably smaller in magnitude.

Preferably, three, in particular absolute, angular velocities are sensed in one direction in each case, one direction being along an axis of rotation of a rotor of the wind power installation, and the other directions each being perpendicular thereto and perpendicular to each other.

It is thus proposed in particular to sense three, preferably exactly three, angular velocities, which in particular differ from each other in their direction.

A first angular velocity about the axis of rotation of the rotor of the wind power installation.

A second angular velocity perpendicular to the first angular velocity.

A third angular velocity perpendicular to the first angular velocity and perpendicular to the second angular velocity.

Preferably, the angular velocities are orthogonal to each other.

Preferably, the reference value is a rotor position, preferably the angle of a rotation of the rotor about a rotor axis relative to the nacelle.

It is thus also proposed in particular to sense, as a reference value, the rotation of the hub relative to the nacelle, preferably about the axis of rotation of the rotor.

The rotor position thus indicates in particular the position of the rotor of the wind power installation, preferably relative to the nacelle.

Preferably, the state variable represents a tilt speed of the nacelle of the wind power installation.

Preferably, the state variable represents a tilt speed of the nacelle of the wind power installation about an axis that is perpendicular to the main axis of rotation and lies in a horizontal plane with the latter.

Preferably, the state variable is determined at least by use of an approximation, which in particular takes into consideration a rotation of a measurement axis with respect to the axis of rotation and/or a horizontal axis of the wind power installation, for example by means of:

$$( \begin{matrix}{ω}_{Nac , tilt , x} \\ {ω}_{Nac , tilt , y} \\ {ω}_{Nac , tilt , z}\end{matrix} ) = ( \begin{matrix}1 & 0 & 0 \\ 0 & cos ( - γ ) & - sin ( - γ ) \\ 0 & sin ( - γ ) & cos ( - γ )\end{matrix} ) ( \begin{matrix}{ω}_{Gyro , x} \\ {ω}_{Gyro , y} \\ {ω}_{Gyro , z}\end{matrix} ) .$$

If, for example, a rotation rate sensor is used that is located in the hub of the wind power installation, the measurement axis of this rotation rate sensor can be rotated, or tilted, relative to the axis of rotation of the rotor of the wind power installation, for example by an angle.

For this, it is then proposed to calculate this rotation, or tilt, by means of an approximation.

In another embodiment, the axis of the rotation rate sensor may also lie in or parallel to the axis of rotation of the wind power installation.

In addition or alternatively, the axis of rotation of the wind power installation may also be tilted by an angle to the horizontal axis of the wind power installation, the so-called tilt angle. This can then be taken into consideration, for example, according to the above equation.

Preferably, the tilt angle describes a tilting of the axis of rotation of the rotor of the wind power installation relative to a horizontal plane, or the horizontal plane, of the wind power installation.

Preferably, the at least one angular velocity is filtered before determination of the state variable, in particular by means of a bandpass filter, preferably in order to obtain a second tower eigenmode.

It is thus proposed in particular to filter the sensed (measurement) variables, in particular in such a way that conclusions can be drawn about the second tower eigenmode.

Preferably, the controlling of the wind power installation is effected in consideration of, in particular with observation of, the state variable.

It is thus also proposed in particular to take the state variable into consideration in the control process, in particular to observe it.

In particular, controlling in this case is effected in such a manner that the state variable decreases, preferably decreases in magnitude.

Preferably, the state variable for controlling the wind power installation is filtered, for example by means of a low-pass filter.

Provided is a wind power installation at least comprising a sensor, for example a rotation rate sensor and/or a magnetic tape sensor, and a control unit that is configured to execute a method described above or below.

The rotation rate sensor is preferably embodied as a gyroscope.

The magnetic tape sensor is preferably located on the shaft of the main axis of rotation.

Also proposed according to the invention is a method for sensing a second eigenmode of a tower of a wind power installation, comprising the steps of: sensing at least one rate of rotation of the wind power installation; determining the tilt speed of the nacelle from the sensed rate of rotation; filtering the tilt speed of the nacelle in order to determine the second eigenmode of the tower of the wind power installation; and controlling the wind power installation in dependence on the second eigenmode of the tower of the wind power installation, in particular such that the frequency of the second eigenmode decreases.

The second tower eigenmode results in a deflection of the tower at approximately ⅔ of the tower height, and in a corresponding frontal or lateral tilting of the nacelle. The wind power installation is controlled in dependence on this.

The deflection results in corresponding loads that reduce the lifetime of the tower.

Preferably, at least one relative angular velocity between the nacelle and the hub is also sensed.

### BRIEF DESCRIPTION OF THE SEVERAL VIEWS OF THE DRAWINGS

The present invention is explained in more detail below and with reference to the accompanying figures, with the same references being used for components or assemblies that are the same or similar.

FIG. 1A shows in schematic form, by way of example, a perspective view of a wind power installation in one embodiment.

FIG. 1B shows in schematic form, by way of example, the axes of a wind power installation.

FIG. 2 shows in schematic form, by way of example, a Campbell diagram for a tower of a wind power installation.

FIG. 3A shows in schematic form, by way of example, an oscillation of a wind power installation, in particular a pitching of a nacelle.

FIG. 3B shows in schematic form, by way of example, an oscillation of a wind power installation, in particular a rolling of a nacelle.

FIG. 4A shows in schematic form, by way of example, a method for operating a wind power installation according to one embodiment, in particular for a pitching of a nacelle.

FIG. 4B shows in schematic form, by way of example, a method for operating a wind power installation according to one embodiment, in particular for a rolling of a nacelle.

FIG. 5 shows in schematic form, by way of example, a possibility for determining a tilt speed for a second tower eigenmode.

### DETAILED DESCRIPTION

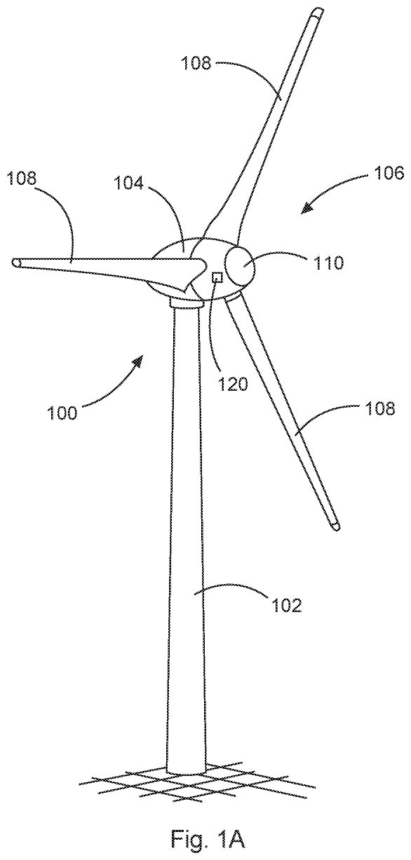

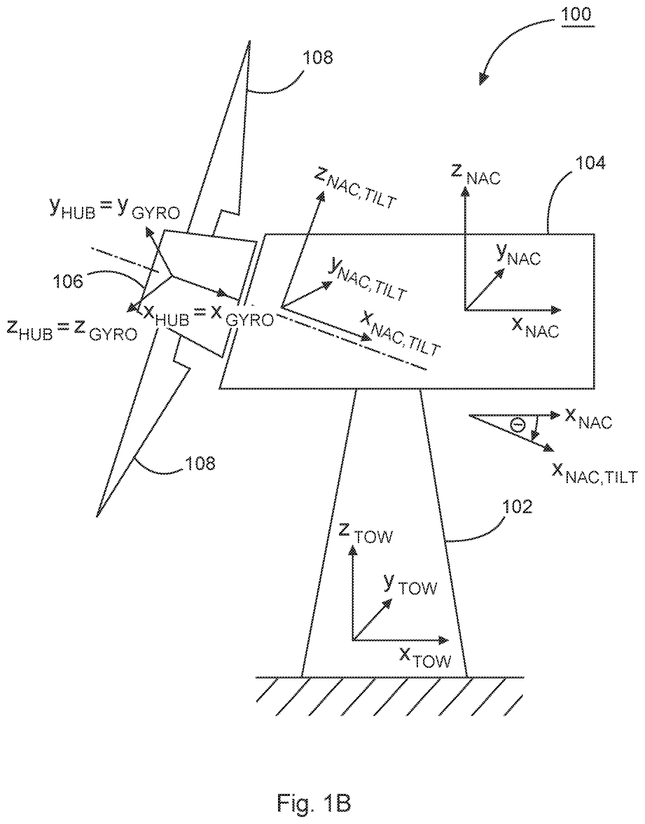

FIG. 1A shows a perspective view of a wind power installation 100.

The wind power installation 100 is embodied as a horizontal rotor and comprises a tower 102 and a nacelle 104.

Located on a hub 110 on the nacelle 104 there is an aerodynamic rotor 106 that has three rotor blades 108.

When in operation, the aerodynamic rotor 106 is caused by the wind to execute a rotatory motion about an axis of rotation mounted substantially horizontally on the tower, and thereby drives a generator in the nacelle.

The generator thereby produces a current to be fed in, which is fed into an electrical supply grid by means of a converter arrangement.

There is also a rotation rate sensor 120 located in the rotor 106, in particular in the hub 110, and preferably to execute a method described above or below.

FIG. 1B shows in schematic form, by way of example, the axes of a wind power installation 100.

The wind power installation 100 comprises a tower 102, a nacelle 104, a rotor 106 and rotor blades 108.

The orientation of the tower 102 can be described by means of the axes x_{TOW}, y_{TOW}, z_{TOW}. The orientation of the nacelle 104 can be described by means of the axes x_{NAC}, y_{NAC}, z_{NAC}. The nacelle 104 is also preferably arranged perpendicularly to the tower 102. In particular, this results in the axes x_{TOW}, y_{TOW}, z_{TOW} of the tower 102 and the axes x_{NAC}, y_{NAC}, z_{NAC} of the nacelle being parallel to each other.

The aerodynamic rotor 106 is further arranged such that it is tilted at an angle Θ, the so-called tilt angle, on the nacelle 104 and in particular tilted about an axis, in particular y_{Nac}.

The aerodynamic rotor 106 can be described by means of the axes x_{ROT}, y_{ROT}, z_{ROT}.

If the rotation rate sensor, in particular the gyroscope, is located in the hub, i.e., within the aerodynamic rotor 106, the axes x_{GYRO}, y_{GYRO}, z_{GYRO} of the rotation rate sensor and of the aerodynamic rotor 106 coincide.

Since the rotor 106 is arranged such that it is tilted on the nacelle, the rotation rate sensor is also tilted relative to the nacelle and thus also arranged such that it is tilted relative to the main axis of rotation x_{NAC} of the wind power installation, in particular by the angle Θ.

In addition, the rotor 106 is rotated by an angle γ, preferably a time-varying angle γ(t), along an axis x_{Nac,tilt} with respect to the nacelle.

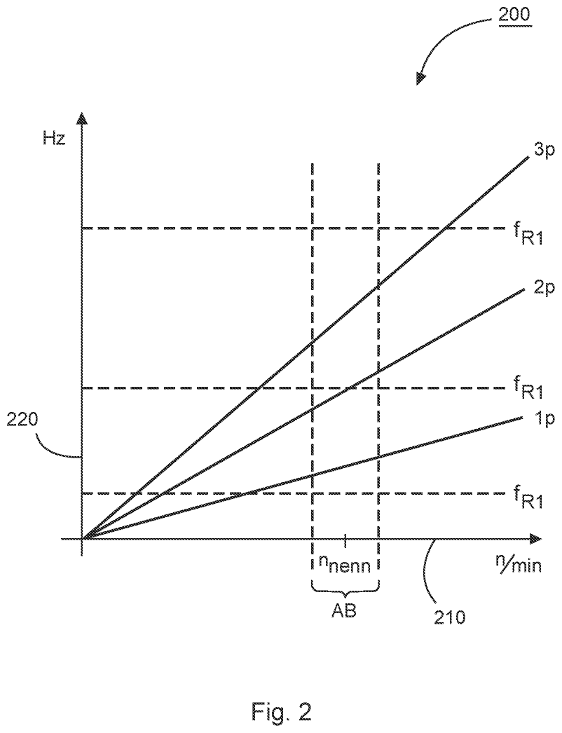

FIG. 2 shows in schematic form, by way of example, a Campbell diagram 200 for a tower of a wind power installation.

The Campbell diagram 200 is realized as a Cartesian coordinate system, with the rotational speed of the rotor of the wind power installation being plotted on the abscissa 210, in revolutions per minute, and the eigenfrequency of the wind power installation, in particular of the tower, being plotted on the ordinate 220, in Hertz.

Wind power installations are usually constructed and designed for a particular operating range AB, for example for a particular nominal rotational speed nₙₑₙₙ. The nominal rotational speed nₙₑₙₙ is, for example, 12 revolutions per minute. In order to attain the operating range AB, it is necessary, for example, for the wind power installation to be started up or deactivated.

In addition, the tower of the wind power installation has at least one first eigenfrequency f_{R1}.

In the case of a stiff-stiff tower, the first eigenfrequency f_{R1}, i.e., the lowest resonance frequency, of the tower in the operating range AB is above three times the nominal rotational speed (3p).

In the case of a soft-stiff tower, the first eigenfrequency f_{R1}, i.e., the lowest resonance frequency, of the tower in the operating range AB is below three times the nominal rotational speed (3p) and above one times the nominal rotational speed (1p).

In the case of a soft-soft tower, the first eigenfrequency f_{R1}, i.e., the lowest resonance frequency, of the tower in the operating range is below one times the nominal rotational speed (1p).

The method described herein is preferably used for wind power installations that have a soft-soft tower.

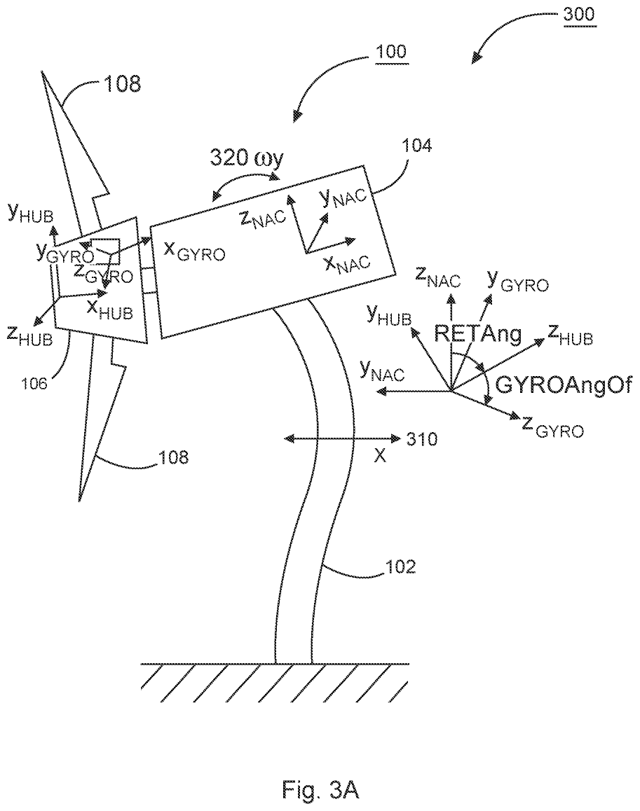

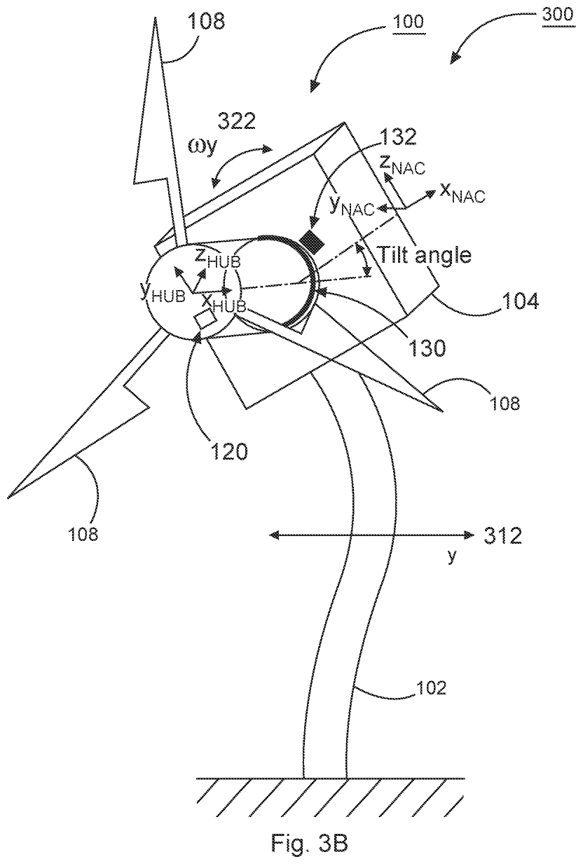

FIG. 3A shows in schematic form, by way of example, an oscillation 300 of a wind power installation as shown in FIGS. 1A and 1B.

The oscillation 300 is composed substantially of an oscillating deflection of the tower 310 in the x-direction, i.e., along the main axis of the wind power installation, and an associated forward-backward motion 320 of the nacelle along the main axis of rotation, or about the y-axis, the so-called pitching of the nacelle.

The cause of this oscillation 300 is the second tower eigenmode.

FIG. 3B shows in schematic form, by way of example, an oscillation 300 of a wind power installation as shown in FIGS. 1A and 1B.

The oscillation 300 is composed substantially of an oscillating deflection 312 of the tower 100 in the y-direction, i.e., about the main axis of the wind power installation 100, and an associated sideways motion 322 of the nacelle about the main axis of rotation, or along the y-axis, the so-called rolling of the nacelle.

The cause of this oscillation 300 is the second tower eigenmode of the tower 102 of the wind power installation 100.

In order to sense this oscillation 300, there is at least one magnetic tape sensor 130 located on the main axis, for example on the shaft of the rotor, and a reader head 132 for the magnetic sensor tape 130 located in the nacelle 104.

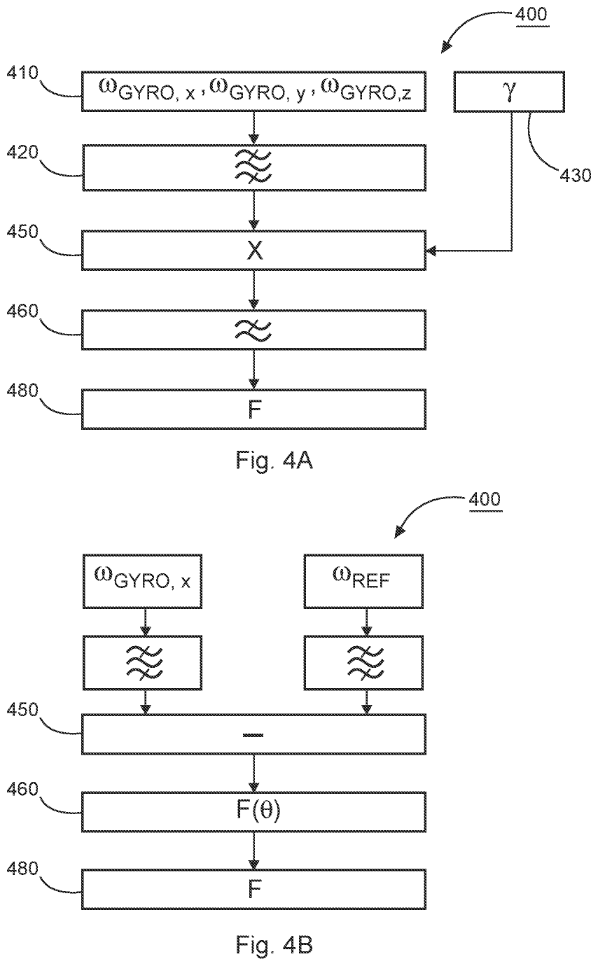

FIG. 4A shows in schematic form, by way of example, a method 400 for operating a wind power installation according to one embodiment, in particular for a pitching of a nacelle.

In a first step 410, the angular velocities ω_{GYRO,x}, ω_{GYRO,y}, ω_{GYRO,z} of the wind power installation 100 are sensed, in particular the angular velocities ω_{GYRO,x}, ω_{GYRO,y}, ω_{GYRO,z} of the nacelle, for example by means of a rotation rate sensor in the hub of the wind power installation.

Preferably, in a next step 420, the angular velocities ω_{GYRO,x}, ω_{GYRO,y}, ω_{GYRO,z} sensed in this way are filtered, in particular for frequencies caused by the second tower eigenmodes. The filtering is preferably effected by means of a bandpass filter.

In addition, in a further step 430, a reference value γ for the angular velocities ω_{GYRO,x}, ω_{GYRO,y}, ω_{GYRO,z} is sensed, in particular the rotor position in the form of a relative angle of rotation, in particular of the hub relative to the nacelle.

In a further step 450, a state variable is determined, for example the tilt speed ω_{Nac.y} of the nacelle about the y-axis is determined, the so-called pitching.

Preferably, the state variable is also filtered in a further step 460, for example by means of a low-pass filter.

Finally, in a further step 480, the wind power installation is controlled in dependence on the state variable, for example by means of control signals F.

FIG. 4B shows in schematic form, by way of example, a method 400 for operating a wind power installation according to one embodiment, in particular for a pitching of a nacelle.

In a first step 410, the angular velocities ω_{GYRO,x} of the wind power installation 100 are sensed, in particular the angular velocities ω_{GYRO,x} of the nacelle about the main axis (x), for example by means of a rotation rate sensor in the hub of the wind power installation.

Preferably, in a next step 420 the angular velocity ω_{GYRO,x} sensed in this way is filtered, in particular for frequencies caused by the second tower eigenmodes. The filtering is preferably effected by means of a bandpass filter.

In addition, in a further step 430, a reference value ω_{REF} for the angular velocities ω_{GYRO,x} is sensed, in particular the relative rotational speed of the rotor of the wind power installation, for example by means of a magnetic tape sensor 130.

Preferably, in a next step 440, the reference value ω_{REF} sensed in this way is likewise filtered by means of a bandpass filter.

In a further step 450, a state variable is determined, for example the tilt speed ω_{Nac.x} of the nacelle about the x-axis, the so-called rolling. For this it may be necessary, for example, to take into consideration a tilt angle Θ described above or below, for example because the rotation rate sensor is tilted by this angle Θ relative to the main axis of rotation.

Finally, in a further step 460, the wind power installation is controlled in dependence on the state variable, for example by means of control signals F.

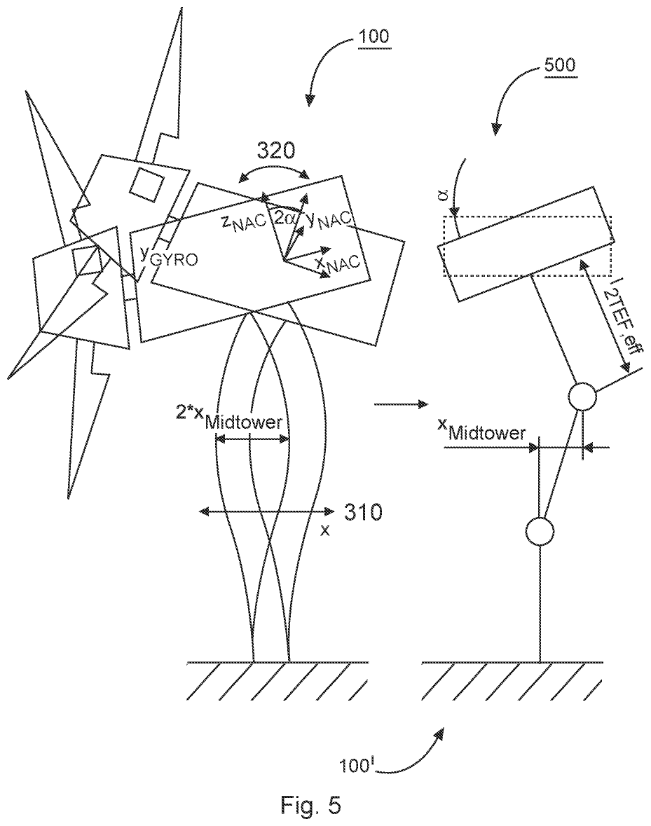

FIG. 5 shows in schematic form, by way of example, a possibility for determining a tilt speed for a second tower eigenmode, in particular by means of a model of a wind power installation 500, preferably of low order.

The wind power installation 100, for example as shown in FIG. 1A or 1B, is linearized for this purpose. This is effected below using the example of a pitching of the wind power installation, for example as shown in FIG. 3.

The tilt α of the nacelle with respect to the normal state is as follows

$$sin α = \frac{{x}_{Midtower}}{{l}_{2 TEF , eff}} ,$$

wherein
x_{Midtower} is the deflection of the tower in the middle of the tower, and l_{2TEF,eff} is the effective length of the tower for the second tower eigenmode.

Using the equation of motion:

$${ω}_{Nac , max} = \frac{d α}{dt}$$

this gives:

$${ω}_{Nac , max} = 2 π {f}_{2 TEF} \frac{{\hat{x}}_{Midtower}}{{l}_{2 TEF , eff}} ,$$

wherein
\hat{x}_{Midtower} describes the maximum deflection of the tower, and f_{2TEF} describes the frequency of the second tower eigenmode.

The corresponding linearization 500′ is depicted alongside only wind power installation 100.

### LIST OF REFERENCES

100 wind power installation
102 tower, in particular of the wind power installation
104 nacelle, in particular of the wind power installation
106 aerodynamic rotor, in particular of the wind power installation
108 rotor blade, in particular of the wind power installation
110 spinner, in particular of the wind power installation
120 rotation rate sensor, in particular of the wind power installation
130 magnetic sensor tape
132 reader head, in particular for the magnetic sensor tape
200 Campbell diagram
300 oscillating of a wind power installation, in particular pitching of the nacelle
310 oscillating deflection of the tower
312 oscillating deflection of the tower
320 forward-backward motion of the nacelle
322 sideways motion of the nacelle
400 method for operating a wind power installation
410, 420, . . . method steps
AB (rotational speed) operating range, in particular of the wind power installation
F control signal
n rotational speed, in particular of the rotor of the wind power installation
nₙₑₙₙ nominal rotational speed, in particular of the rotor of the wind power installation
1p one times nominal rotational speed, in particular of the rotor of the wind power installation
2p two times nominal rotational speed, in particular of the rotor of the wind power installation
3p three times nominal rotational speed, in particular of the rotor of the wind power installation
X_{HUB} x-axis of the hub
x_{NAC} x-axis of the nacelle
x_{TOW} x-axis of the tower
y_{HUB} y-axis of the hub
y_{NAC} y-axis of the nacelle
y_{TOW} y-axis of the tower
z_{HUB} z-axis of the hub
z_{NAC} z-axis of the nacelle
z_{TOW} z-axis of the tower
ω_{GYRO,x} angular velocity of the rotation rate sensor, in particular about the x-axis
ω_{GYRO,y} angular velocity of the rotation rate sensor, in particular about the y-axis
ω_{GYRO,z} angular velocity of the rotation rate sensor, in particular about the z-axis
ω_{REF} reference value, in particular rotational speed of the rotor
α tilt of the nacelle
x_{Midtower} deflection of the tower, in particular in the middle of the tower
l_{2TEF,eff}: the effective length of the tower, in particular for the second tower eigenmode
γ reference value, in particular rotor position
Θ tilt angle

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method for operating a wind power installation, the method comprising:
sensing an angular velocity of the wind power installation;
sensing a reference value for the angular velocity;
determining a state variable of the wind power installation based on the angular velocity and the reference value; and
controlling the wind power installation in dependence on the state variable.

2. The method as claimed in claim 1, wherein the sensing the angular velocity of the wind power installation comprises using a rotation rate sensor in a hub of the wind power installation, wherein the rotation rate sensor is configured to sense a tilt of the nacelle.

3. The method as claimed in claim 1, wherein the controlling causes the state variable to become smaller.

4. The method as claimed in claim 1, wherein the angular velocity is sensed in one direction, the one direction being along an axis of rotation of a rotor of the wind power installation.

5. The method as claimed in claim 1, wherein the axis of rotation is a main axis of rotation.

6. The method as claimed in claim 1, wherein the reference value is a relative rotational speed about an axis of rotation of a rotor of a wind power installation and is sensed by a magnetic tape sensor.

7. The method as claimed in claim 1, wherein the state variable is indicative of a tilt speed of the nacelle of the wind power installation.

8. The method as claimed in claim 1, wherein determining the state variable includes a difference of the angular velocity and the reference value.

9. The method as claimed in claim 8, wherein the state variable is further based on a tilt angle of the axis of rotation of the rotor relative to a horizontal plane.

10. The method as claimed in claim 1, comprising filtering the angular velocity and the reference value before the determining the state variable.

11. The method as claimed in claim 10, wherein the filtering comprises using a bandpass filter to obtain a second tower eigenmode.

12. The method as claimed in claim 1, wherein the controlling of the wind power installation is effected with observation of the state variable.

13. The method as claimed at least in claim 1, further comprising filtering the state variable for controlling the wind power installation.

14. The method as claimed at least in claim 1, wherein the filtering comprises using a low-pass filter.

15. A wind power installation, comprising:
a first sensor configured to sense angular velocity of the wind power installation;
a second sensor configured to sense a reference value for the angular velocity; and
a controller configured to:
receive signals indicative of the angular velocity and the reference value;
determine a state variable of the wind power installation based on the angular velocity and the reference value; and
control the wind power installation in dependence on the state variable.

16. The wind power installation as claimed in claim 15, wherein the first sensor is a rotation rate sensor and the second sensor is a magnetic tape sensor.

17. A method comprising:
sensing a second eigenmode of a tower of a wind power installation, the wind power installation including a nacelle on the tower, the sensing comprising:
sensing a rate of rotation of the wind power installation;
determining a tilt speed of the nacelle from the sensed rate of rotation;
filtering the tilt speed of the nacelle to determine the second eigenmode of the tower of the wind power installation; and
controlling the wind power installation in dependence on the second eigenmode of the tower of the wind power installation.

18. The method as claimed in claim 17, further comprising:
sensing a relative angular velocity between the nacelle and the hub.

19. The method as claimed in claim 17, wherein controlling the wind power installation in dependence on the second eigenmode of the tower of the wind power installation comprises controlling the wind power installation such that the frequency of the second eigenmode decreases.
